(19) United States
(12) Patent Application Publication
(10) Pub. No.: US 2006/0048986 A1
(43) Pub. Date: Mar. 9, 2006

(54) Vehicle hood opening for cooling airflow and method of cooling a heat-dissipating component

(76) Inventor: Daniel Christopher Bracciano, Grosse Pointe Shores, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 10/937,086

(22) Filed: Sep. 9, 2004

(51) Int. Cl. B62D 25/10

(52) U.S. Cl. 180/69.2

(57) ABSTRACT

A vehicle hood is formed to define an air inlet in fluid communication with a heat-dissipating component such as an air conditioning condenser to permit outside air to flow through the inlet for cooling of the heat-dissipating component. Notably, the air inlet is different from the grille opening traditionally used to cool a condenser and a vehicle radiator; the inlet is located rearward on the hood, permitting the condenser to be located apart from the radiator in the front compartment. A method of cooling a heat-dissipating component is also provided.

### TECHNICAL FIELD

This invention relates to air flow arrangements for cooling a heat-dissipating component on a vehicle; specifically, the invention relates to the use of an air inlet in the vehicle hood.

### BACKGROUND OF THE INVENTION

Vehicle air conditioning systems typically employ a condenser in which high pressure, hot refrigerant gas is cooled to high pressure, cooler refrigerant liquid. The dissipation of heat in the condenser allows the refrigerant to condense to a liquid form. The refrigerant then runs through an expansion valve which allows it to evaporate to become cold, low pressure refrigerant gas that is routed through a set of coils that allows the gas to absorb heat and cool down the passenger compartment of the vehicle. The heated gas is then directed through a compressor which causes it to become hot, high pressure refrigerant gas.

Efficient operation of the air conditioning system requires that the condenser coils are adequately cooled to allow the high pressure, hot gas to cool to high pressure, cold liquid for cooling air directed to the passenger compartment. Typically, the air conditioning condenser is placed foremost in a vehicle engine or hood compartment adjacent to a grille formed in a forward-facing surface of the vehicle above the front bumper. Air flows through the grille to cool the condenser. Fans may be mounted adjacent to the condenser to pull air through the grille. Additionally, air is naturally forced through the grille during forward vehicle movement.

A radiator employed to cool the vehicle engine is typically placed just behind the air conditioning condenser in the front compartment. The air pulled by the fans through the grille to cool the condenser also cools the radiator. The cooling air, having passed across the condenser and radiator, exits to the open space below the front compartment (i.e., between the ground and the vehicle).

### SUMMARY OF THE INVENTION

By utilizing a novel vehicle hood and novel placement of a heat-dissipating component, the invention provides an efficient design for cooling a heat-dissipating component such as an air conditioning condenser or a radiator in a front compartment of a vehicle. As used herein, “heat-dissipating component” includes any vehicle component typically cooled by convective heat transfer via cooling air flow, the vehicle component thereby acting as a heat-exchanger. The invention provides a vehicle hood having an air inlet positioned in air flow relationship with respect to a heat-dissipating component to permit outside air to flow through the air inlet and across the heat-dissipating component, thereby cooling the heat-dissipating component. Preferably, the vehicle hood includes a generally upward-facing surface and the air inlet is formed in this surface such that it is also generally upward-facing.

In one aspect of the invention, a diverter structure, such as a scoop, is mounted at the air inlet to direct additional outside air through the air inlet when the vehicle moves (i.e., ram air), thereby increasing cooling of the heat-dissipating component.

In yet another aspect of the invention, a grille is positioned at the air inlet. The grille decreases the maximum opening size of the air inlet, and therefore is useful for keeping unwanted items such as leaves and other debris from entering the air inlet.

In still another aspect of the invention, a duct is connected between the air inlet and the heat-dissipating component for directing air flowing through the air inlet to the heat-dissipating component to provide convective cooling thereof. Seals may be used to seal the duct to the structure defining the air inlet and to the outer edges of the condenser.

The invention also provides a vehicle that includes a hood extending over and at least partially defining a compartment in a substantially forward portion of the vehicle. The heat-dissipating component is located within the compartment. The hood defines an air inlet positioned in air flow relationship with respect to the heat-dissipating component to permit outside air to flow through the air inlet and across the heat-dissipating component, thereby cooling the heat-dissipating component. Preferably, the heat-dissipating component is a condenser for a vehicle air conditioning system. Alternatively, the heat-dissipating component may be a radiator for cooling a vehicle power plant such as a fuel cell or an engine. The diverter structure, duct, and seal described above with respect to the vehicle hood may be employed on the vehicle. Preferably, the heat-dissipating component is an air-conditioning condenser located substantially rearward in the front compartment with respect to a vehicle radiator and separate air flow (i.e., provided through a separate air inlet than that formed in the hood to provide air flow to the condenser) is utilized for cooling the radiator than is used for cooling the condenser.

In another aspect of the invention, one or more fans may be located adjacent to the heat-dissipating component. The fans are operable for at least partially causing the air flow through the air inlet. Additional air flow may be due to the ram air scoop attached to the vehicle hood above the air inlet.

In yet another aspect of the invention, the vehicle includes a steering system, a braking system, a suspension system and an energy conversion system that includes a fuel cell. At least one of the systems is responsive to non-mechanical control signals. Accordingly, the vehicle may be a by-wire vehicle. Because fuel cells typically generate large quantities of heat, optimization of the power plant cooling system, including the radiators, is desirable. The invention increases radiator cooling efficiency by enabling alternate placement of the condenser: by moving the condenser away from the radiator and providing separate, dedicated air flow for cooling the condenser, cooling air at the radiator may be completely dedicated to the radiator. Thus, smaller fans may be utilized, as the large pressure drop across a stacked condenser and radiator is avoided.

A method of cooling a heat-dissipating component located in the front compartment of a vehicle at least partially defined by a vehicle hood includes forming an air inlet in the hood. The method further includes forcing air through the inlet and across the heat-dissipating component to cool the heat-dissipating component. The forcing step may be at least partially via a fan mounted in the front compartment adjacent to the heat-dissipating component. The fan is operable to pull air through the air inlet and across the heat-dissipating component for cooling of the heat-dissipating component.

In another aspect of the invention, the method includes mounting a diverter (i.e., a scoop) at the air inlet such that the diverter extends above the air inlet. Accordingly, the method further includes diverting additional air through the air inlet via the diverter for further cooling of the heat-dissipating component.

In a further aspect of the invention, the method includes mounting a second heat-dissipating component in the front compartment in air flow relationship with a second air inlet formed on said vehicle for providing cooling air flow to said second heat-dissipating component. The second heat-dissipating component may be a radiator for cooling of an energy conversion system on the vehicle. The method may further include mounting a condenser (i.e., the first heat-dissipating component of the forcing step, above) in the front compartment at a location spaced substantially apart from and rearward of the radiator such that said condenser is not substantially cooled by cooling air flow provided through the second air inlet. Accordingly, by spacing the radiator and condenser apart from one another and providing a separate air flow arrangement for the condenser, the air flow used for cooling the radiator may be dedicated solely to the radiator, thus improving the efficiency of radiator cooling on the vehicle.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective illustration of a vehicle hood having an air inlet for cooling a condenser (shown in phantom) on a vehicle (shown in phantom);

FIG. 2A is a schematic side view illustration in partial cross sectional view showing the hood of FIG. 1 including an optional air scoop mounted at the air inlet;

FIG. 2B is a schematic perspective illustration of a duct sealable between the hood and condenser; and

FIG. 3 is a flow diagram illustrating a method of cooling a condenser for a vehicle air conditioning system.

### DESCRIPTION OF THE PREFERRED EMBODIMENTS

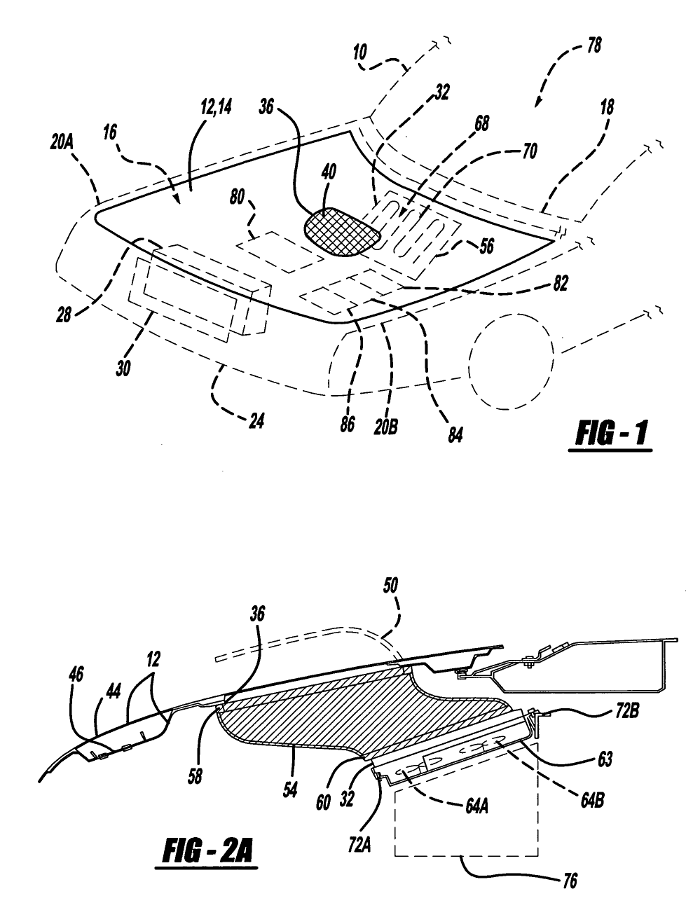

Referring to the drawings, wherein like reference numerals refer to like components, FIG. 1 shows a vehicle 10 having a hood 12 that extends over and partially covers a front compartment 16 of the vehicle. The front compartment 16 is further defined by the vehicle cowl 18, side panels 20A, 20B and a bumper/grille area 24.

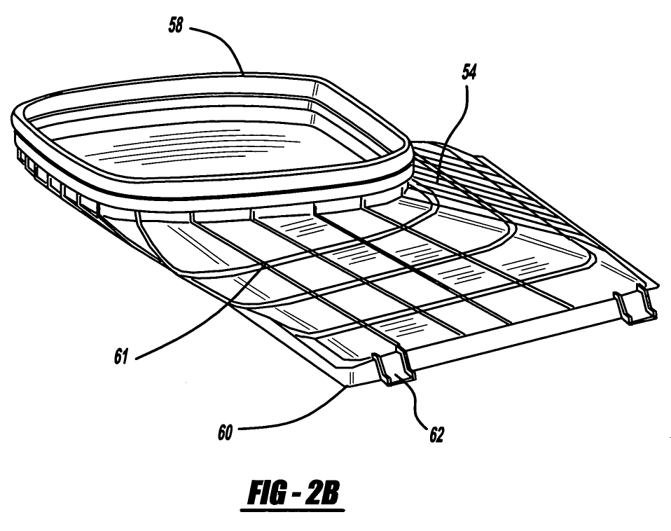

A radiator 28 utilized to cool a vehicle power plant (such as a fuel cell) is positioned frontward in the front compartment 16 adjacent to a grille opening 30. One or more fans (shown in and discussed with respect to FIG. 2A) may be used to pull air through the grille opening 30 for cooling of the radiator 28. Additionally, air flow generated during vehicle movement enters through the grille opening 30 for cooling the radiator 28.

The front compartment 16 also contains an air conditioning condenser 32. As may be seen in FIG. 1, the air conditioning condenser 32 is located more rearward in the front compartment 16 than the radiator 28. The air conditioning condenser 32 is located toward the cowl 18 in a semi-horizontal position (i.e., the breadth of the condenser 32 is generally upward-facing).

The hood 12 is formed with an air inlet 36. The air inlet 36 may be referred to as a first air inlet and the grille opening 30 may be referred to as a second air inlet. The air inlet 36 is positioned rearward on the hood 12, toward the vehicle cowl 18. The air inlet 36 serves a different purpose than the typical grille inlet 30 located forward in the front vehicle bumper/grille area 24. Specifically, the air inlet 36 provides air flow to the condenser 32 for cooling the condenser. The air inlet 36 is positioned in series air flows relationship with the condenser 32. The air inlet 36 may be partially covered with a grille 40 formed with a plurality of apertures. The grille acts to decrease the maximum opening size of the air inlet 36 (i.e., divides the total area of the inlet determined by the circumference of the inlet into smaller openings determined by the apertures in the grille). Thus, the grille 40 prohibits the passage of leaves and other debris through the air inlet 36. As may be seen in FIG. 1, the hood 12 includes a generally upward-facing surface 14. The air inlet 36 is formed in the upward-facing surface 14 such that it is also generally upward-facing. The breadth of the air conditioning condenser 32 is generally parallel with the upward-facing surface.

Referring to FIG. 2A, it may be seen that the hood 12 is comprised of a hood outer panel 44 connected to a hood inner panel 46, as is understood in the art. The air inlet 36 is formed in both the outer and inner panels 44, 46.

An optional diverter 50 (also referred to as an air scoop) may be mounted at the air inlet 36 to further direct outside air through the air inlet 36. Preferably, the diverter 50 extends generally upward and forward from the rearward edge of the air inlet 36 and may be mounted to the hood 12 or integrally formed therein. Air scoops are well understood in the art, as they have been traditionally used to provide ram air for engine combustion.

A duct 54 is sealed to the hood inner panel 46 at one end and to the outer periphery 56 (better viewed in FIG. 1) of the condenser 32 at an opposing end. A hood to duct gasket 58 and a duct to condenser seal 60 integrally formed in the duct 54 may be employed to seal the duct to the hood inner panel 46 and to the condenser 32, respectively. A variety of other sealing means such as adhesives and other fastening devices may be used to establish a substantially sealed connection between the duct 54 and the hood 12 and between the duct 54 and the condenser 32, respectively. The duct 54 may be formed from a variety of materials such as aluminum or flexible or rigid plastic. Notably, when the hood 12 is lifted to access the front compartment 16, the hood inner panel 46 lifts away from the gasket 58 and the duct 54 remains attached to the condenser 32. Optionally, a separate front compartment cover (not shown) may surround the front compartment 16 when the hood is open, thus blocking a view of components within the front compartment 16, while still allowing air flow through the duct 54.

Referring to FIG. 2B, optional strengthening ribs 61 are formed in the duct 54 for added stiffness. Additionally, optional tabs 62 are formed in the duct 54. The tabs 62 snap into openings (not shown) formed in the condenser 32 to secure the duct 54 to the condenser 32.

Referring to FIG. 2A, a condenser support 63 also supports condenser fans 64A, 64B such that the fans 64A, 64B are positioned adjacent the condenser 32 opposite the duct 54 (i.e., under the condenser 32). Within the scope of the invention, the fans 64A, 64B, may be located above the condenser 32. The condenser support 63 is mounted at frame supports 72A, 72B. A modular HVAC unit 76 is also positioned in the front compartment and may include an evaporator, an air conditioning compressor, an inverter and structure forming air distribution passages. The function of such components will be well understood by those skilled in the art. The fans 64A, 64B operate to pull outside air through the air inlet 36 and the duct 54 across the condenser 32. As shown in FIG. 1, the condenser 32 includes a plurality of pass through passages 68 formed between the coiled or latticed condenser coil 70. Air is pulled by the fans 64A, 64B through the pass through passages 68 within the condenser 32 to cool the condenser coil 70 (i.e., the air flows across the condenser 32). If the optional diverter 50 is used, additional air is forced through the air inlet 36 as the vehicle 10 moves forward (i.e., more air than would be pulled through the air inlet 36 by the fans 64A, 64B alone). Air flow that has crossed the condenser 32 exits the front compartment 16 through the bottom of the compartment beneath the vehicle 10. Because the space below the compartment 16 is a low pressure area, air flow resistance (and thus fan energy requirements) is minimized. Cooling fluid within the condenser 32 is passed to the HVAC unit 76 to cool the interior passenger compartment 78 (shown in FIG. 1). Accordingly, the air conditioning system which includes the condenser 32 and HVAC unit 76 is provided with a separate air cooling path than is used for the radiator 28. By permitting condenser 32 placement that is independent of radiator 28 placement, packaging options within the interior space 16 are broadened and may be optimized for overall cooling system efficiency. For instance, the condenser 32 of FIG. 2A is provided with relatively unobstructed air flow via the air inlet 36. Because the radiator 28 is not stacked directly behind the condenser 32, as is typically the case, cooling of the condenser 32 as well as the radiator 28 is optimized. Accordingly, it may be possible to employ a smaller condenser 32 as well as smaller cooling fans 64A, 64B than used in a typical cooling system, thus reducing cost and overall system energy consumption as well as lowering mass added to the vehicle 10.

Within the scope of the invention, a radiator or other heat-dissipating component may be placed at the air inlet 36 in lieu of or in addition to the condenser 32. The radiator or other heat-dissipating component would be cooled by air flow provided through the air inlet in the same manner as the condenser 32 of FIG. 1 is cooled.

Referring again to FIG. 1, the vehicle 10 includes an energy conversion system 80 which may include an internal combustion engine, an electric motor and/or a fuel cell. The vehicle 10 also includes a steering system 82, a braking system 84, and a suspension system 86. Any or all of the energy conversion system 80, steering system 82, braking system 84 and suspension system 86 may be responsive to non-mechanical control systems (i.e., may be “by-wire” systems). Because vehicles utilizing a fuel cell for conversion of chemical energy to electrical energy may generate relatively large quantities of heat in the conversion process, efficient radiator cooling systems are desirable. Accordingly, by separating the air flow cooling of the condenser 32 from the air flow cooling of the radiator 28, the invention allows for a more efficient, dedicated radiator cooling system.

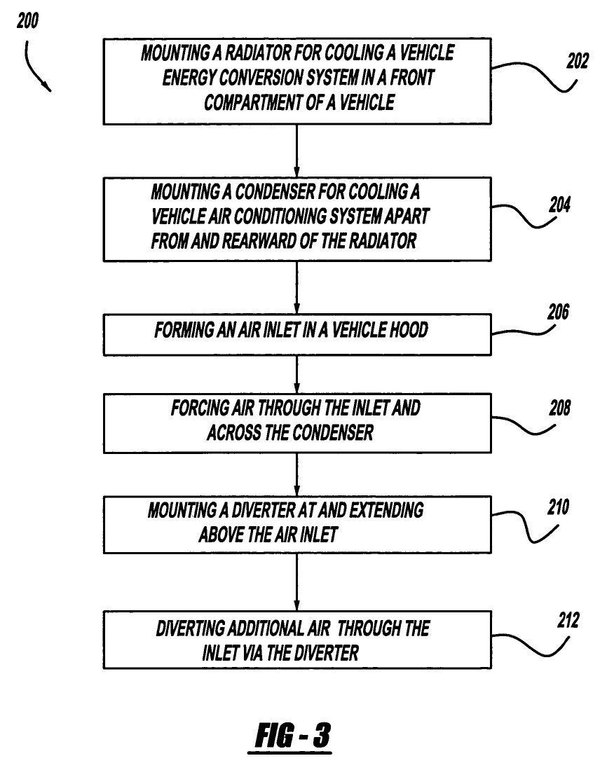

Referring to FIG. 4, the condenser cooling arrangement described with respect to the vehicle 10 above incorporates a method of cooling a heat-dissipating component 200, which may be a condenser for a vehicle air conditioning system. The heat-dissipating component is located in the front compartment in the vehicle. The front compartment is at least partially defined by the vehicle hood. The method 200 may include mounting another heat-dissipating component 202 (i.e., a second heat-dissipating component, such as a radiator for cooling a vehicle energy conversion system) in a front compartment of the vehicle. The method 200 further includes mounting the first heat-dissipating component (e.g., the condenser) apart from and rearward of the second heat-dissipating component (e.g., the radiator) 204. The method 200 includes forming an air inlet in the vehicle hood 206. Preferably, the air inlet is located in the rearward portion of a generally upward-facing surface of the vehicle hood and is generally in the vicinity of the first heat-dissipating component. The method 200 further includes forcing air 208 through the air inlet and across the first heat-dissipating component. Optionally, the method 200 may include mounting a diverter 210 at and extending above the air inlet formed in the hood. Accordingly, the invention 200 may further include diverting additional air 212 through the air inlet via the diverter. Preferably, the second heat-dissipating component is not cooled by step 208, forcing air through the air inlet in the hood (i.e., the first and second heat-dissipating components have separate cooling air paths). The structure described above with respect to FIGS. 1A, 2A and 2B permits the efficient cooling method 200. The steps of the method 200 need not necessarily be performed in the order shown in FIG. 3.

While the best modes for carrying out the invention have been described in detail, those familiar with the art to which this invention relates will recognize various alternative designs and embodiments for practicing the invention within the scope of the appended claims.

1. A vehicle hood for a vehicle having a heat-dissipating component, said hood including:
structure defining an air inlet positioned in air flow relationship with respect to said heat-dissipating component to permit outside air to flow through said air inlet and across said heat-dissipating component thereby cooling said heat-dissipating component.

2. The vehicle hood of claim 1, wherein said hood includes a generally upward-facing surface; and wherein said structure defining an air inlet is said generally upward-facing surface such that said air inlet is also generally upward-facing.

3. The vehicle hood of claim 1, further comprising:
a diverter structure mounted at said air inlet so as to direct additional 5 outside air through said air inlet when the vehicle moves, thereby increasing cooling of said heat-dissipating component.

4. The vehicle hood of claim 3, further comprising:
a grille positioned at said air inlet for decreasing a maximum opening size of said air inlet.

5. The vehicle hood of claim 1, further comprising:
a duct connected between air inlet and said heat-dissipating component for directing air flowing through said air inlet to said heat-dissipating component.

6. The vehicle hood of claim 5, further comprising:
a seal sealing said duct to one of said structure defining an air inlet and substantially outer edges of said heat-dissipating component.

7. A vehicle including:
a hood having a generally upward-facing surface extending over and at least partially defining a compartment in a substantially forward portion of said vehicle;
a heat-dissipating component located within said compartment; and
wherein said generally upward-facing surface of said hood defines an air inlet positioned in air flow relationship with respect to said heat-dissipating component to permit outside air to flow through said inlet and across said heat-dissipating component, thereby cooling said heat-dissipating component.

8. The vehicle of claim 7, wherein said vehicle further includes one of an air conditioning system and a power plant; and wherein said heat-dissipating component is one of a condenser for said air conditioning system and a radiator for cooling said power plant, respectively.

9. The vehicle of claim 7, further comprising:
a diverter structure mounted at said air inlet to direct additional outside air through said air inlet when the vehicle moves, thereby increasing cooling of said heat-dissipating component.

10. The vehicle of claim 7, further comprising:
a duct connected between said air inlet and said heat-dissipating component for directing air flowing through said air inlet to said heat-dissipating component.

11. The vehicle of claim 10, further comprising:
a seal sealing said duct to one of said hood and said heat-dissipating component, respectively.

12. The vehicle of claim 7, wherein said vehicle further includes a power plant and a radiator for cooling said power plant; and wherein said heat-dissipating component is an air conditioning system condenser located substantially rearward in said compartment with respect to said radiator.

13. The vehicle of claim 7, further comprising:
a fan located adjacent to said heat-dissipating component and operable for at least partially causing said air flow through said air inlet.

14. The vehicle of claim 7, further comprising:
a grille positioned at said air inlet for decreasing maximum opening size at said air inlet.

15. The vehicle of claim 7, further comprising:
a steering system, a braking system, a suspension system and an energy conversion system;
wherein said energy conversion system includes a fuel cell; and
wherein at least one of said steering system, said braking system, said suspension system and said energy conversion system is responsive to non-mechanical control signals.

16. A vehicle comprising:
a hood having a generally upward-facing surface extending over and at least partially defining a compartment in a substantially forward portion of said vehicle;
an air conditioning condenser located within said compartment;
wherein said hood defines an air inlet;
a duct connected between said air inlet and said condenser; and
a fan located adjacent to said condenser and operable for at least partially causing air flow through said air inlet and said duct and across said condenser for cooling said condenser.

17. A method of cooling a heat-dissipating component located in a front compartment of a vehicle, said front compartment being at least partially defined by a vehicle hood, said method comprising:
forming an air inlet in said hood; and
forcing air through said inlet and across said heat-dissipating component.

18. The method of claim 17, wherein said forcing is at least partially via a fan mounted in said front compartment adjacent said heat-dissipating component.

19. The method of claim 17, further comprising:
mounting a diverter at said air inlet such that said diverter extends at least partially above said inlet; and
diverting air through said air inlet via said diverter for further cooling of said heat-dissipating component.

20. The method of claim 17, wherein said heat-dissipating component is a first heat-dissipating component and said air inlet is a first air inlet, the method further comprising:
mounting a second heat-dissipating component in said front compartment in air flow relationship with a second air inlet formed on said vehicle for providing cooling air flow to said second heat-dissipating component; and
mounting said first heat-dissipating component in said front compartment at a location spaced substantially apart from and rearward of said second heat-dissipating component such that said first heat-dissipating component is not substantially cooled by said cooling air flow provided through said second air inlet.
